(19) United States
(12) Patent Application Publication
(10) Pub. No.: US 2022/0297834 A1
(43) Pub. Date: Sep. 22, 2022

(54) FLYING BODY

(71) Applicant: AERONEXT INC., Tokyo (JP)

(72) Inventor: Yoichi SUZUKI, Tokyo (JP)

(21) Appl. No.: 17/638,659

(22) PCT Filed: Sep. 20, 2019
(86) PCT No.: PCT/JP2019/037104

§ 371 Date: Feb. 25, 2022

(51) Int. Cl. B64C 39/02

(52) U.S. Cl. CPC B64C 39/024; B64C 2201/021; B64C 2201/102; B64C 2201/165

(57) ABSTRACT

A flying body having more basic structure and safety measures. The flying body according to the present invention a fuselage, a thrust unit for generating thrust connected to the fuselage, a main wing at the fuselage and a tail connected to the fuselage, wherein at least at the time of landing, the main wing is deformably configured with respect to the fuselage so that the main wing and the fuselage comprise landing legs.

### TECHNICAL FIELD

The present invention relates to a flying body.

### BACKGROUND ART

In recent years, various services have been provided using a rotary-flying aircraft such as a drone or an unmanned aerial vehicle (UAV) (hereinafter simply referred to as “flying body”) used for various purposes (for example, refer to Patent Literature 1).

Also, among such flying bodies, there is a flying body disclosed in Patent Literature 2 having a loading part loaded with a baggage.

### PRIOR ART

### Patent Literature

[Patent Literature 1] Japanese Unexamined Patent Publication No. 2017-015697
[Patent Literature 2] Japanese Unexamined Patent Publication No. 2017-159751

### SUMMARY OF THE INVENTION

### Technical Problem

When transporting the above-mentioned baggage, the technique described in Patent Literature 2 is complicated in the structure and does not take measures to cope with a lateral wind when descending, which causes a problem in safety.

Thus, it is an object of the present invention to provide a flying body having more basic structure and safety measures.

### Technical Solution

According to the present invention, there is provided a flying body comprising: a thrust unit for generating thrust, a main wing, a fuselage, and a tail,

wherein at least at the time of landing, the main wing is deformable with respect to the fuselage so that the main wing and the fuselage comprise the landing leg.

### Advantageous Effects

According to the present invention, a flying body having more basic structure and safety measures can be provided.

### BRIEF DESCRIPTION OF THE DRAWINGS

FIG. 1 is illustrating an initial state of a flying body according to the present invention.

FIG. 2 is illustrating a state at the time of ascent of the flying body of FIG. 1.

FIG. 3 is illustrating a state at the time of flight of the flying body of FIG. 1.

FIG. 4 is illustrating a state at the time of descent of the flying body of FIG. 1.

FIG. 5 is illustrating another state at the time of descent of the flying body of FIG. 1.

FIG. 6 is illustrating a landed state of the flying body of FIG. 1.

FIG. 7 is a diagram illustrating a functional block of a flight section of the flying body of FIG. 1.

FIG. 8 is illustrating a modification of the flying body according to the present invention.

### DETAILED DESCRIPTION OF THE EMBODIMENTS

The contents of the embodiments of the present invention will be listed and described. A flying body according to an embodiment of the present invention has the following configuration.

### [Item 1]

A flying body comprising:

a thrust unit for generating thrust;

a main wing;

a fuselage; and

a tail,

wherein the main wing is deformably configured with respect to the fuselage so that the main wing and the fuselage comprise the landing legs at least at the time of landing.

### [Item 2]

The flying body according to Item 1,

wherein the thrust unit and the fuselage are configured to be independently displaceable via a connection part.

### [Item 3]

The flying body according to Item 1 or 2,

wherein the main wing is composed of a pair of wings.

### [Item 4]

The flying body as in one of Items 1-3,

wherein the main wing is at a substantially center of the fuselage.

### <Details of Embodiments>

Hereinafter, a flying body according to embodiments of the present invention will be described with reference to the accompanying drawings.

### <Details of Embodiments According to the Present Invention>

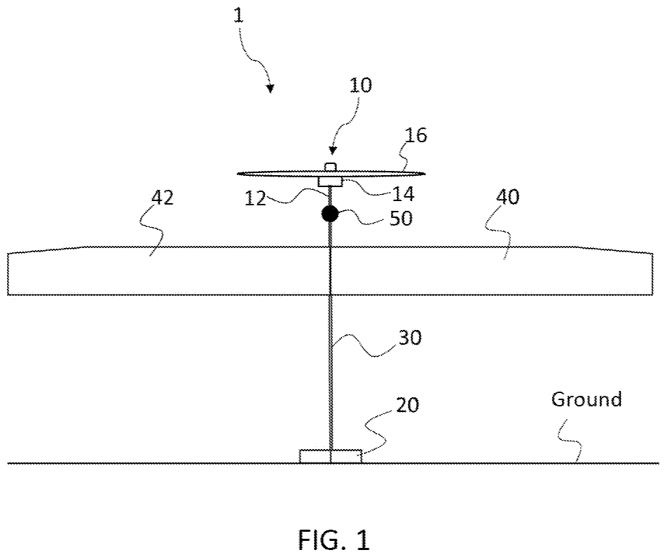

As shown in FIG. 1, a flying body 1 according to an embodiment of the present invention includes a thrust unit 10 having a propeller 16 for generating thrust, a tail 20, a fuselage 30 that connects the thrust unit 10 and the tail 20, and a pair of main wings 40 and 42 provided at the substantially center of the fuselage 30. Further, the thrust unit 10 and the fuselage 30 are configured to be independently displaceable via the connection part 50. The connection part 50 can be a gimbal or the like that can be pivoted around one, two, or three axes.

It should also be noted that the flying body 1 illustrated in the figure is depicted in a simplified manner in order to facilitate the description of the structure of the present invention. For example, the detailed configuration of the control unit and the like is not illustrated.

Further, the axis in the figure represents an absolute axis. The Z axis (Z direction) is a vertical direction, and both the X axis and the Y axis are horizontal directions.

### <Details of Structure>

The thrust unit 10 according to the present embodiment includes a propeller 16, a motor 14 that rotates the propeller 16, and a motor arm 12 that supports the motor 14.

The propeller 16 rotates by receiving output from the motor 14. As the propeller 16 rotates, a propulsive force is generated for taking off the flying body 1 from a departure point, horizontally moving it, and landing it at a destination (details of the flight will be described later). Further, the propeller can rotate rightward, stop, and rotate leftward.

The propeller 16 may have any number of vanes (rotors) (e.g., 1, 2, 3, 4, or more vanes). The shape of the vane can be any shape such as a flat shape, a bent shape, a twisted shape, a tapered shape, or a combination thereof.

In addition, the shape of the vane can be transformed (for example, extendable, foldable, bendable, etc.). The vanes can be symmetrical (having the same upper and lower surfaces) or asymmetric (having differently shaped upper and lower surfaces).

The vanes can be formed to have a geometrical form that is preferable for generating dynamic aerodynamic forces (e.g., lift, thrust) when an airfoil, wing or vane is moved through the air. The geometrical form of the vane can be appropriately selected to optimize the dynamic air characteristics of the vane, such as increasing lift and thrust and reducing a resistance force.

The motor 14 generates the rotation of the propeller 16. For example, a drive unit may include an electric motor, an engine, or the like. The vanes can be driven by the motor and rotate clockwise and/or counterclockwise around a rotation axis of the motor (e.g., the long axis of the motor).

The vanes can all rotate in the same direction, or can also rotate independently. Some of the vanes rotate in one direction and the other vanes rotate in the other direction. All of the vanes can be rotated at the same rotational speed, or can also be rotated at different rotational speeds. The number of rotations can be determined automatically or manually based on the dimensions (for example, size, weight) or the control state (speed, moving direction, etc.) of the moving body.

The motor arm 12 is a member that supports the corresponding motor 14 and propeller 16. The motor arm 12 may include a color-displaying body such as an LED to indicate the flight state, flight direction, etc. of the rotary-flying aircraft. The motor arm 12 according to the present embodiment can be formed of a material appropriately selected from carbon, stainless steel, aluminum, magnesium, etc., or alloys or combinations thereof.

The fuselage 30 has two linear shapes, each having one end connected to the thrust unit 10 and the other end connected to the tail 20.

The main wings 40 and 42 are connected respectively to the fuselage 30. In the present embodiment, at least at the time of landing, the main wings 40 and 42 are deformably configured with respect to the fuselage 30 so that the main wings 40 and 42 and the fuselage 30 comprise the landing legs.

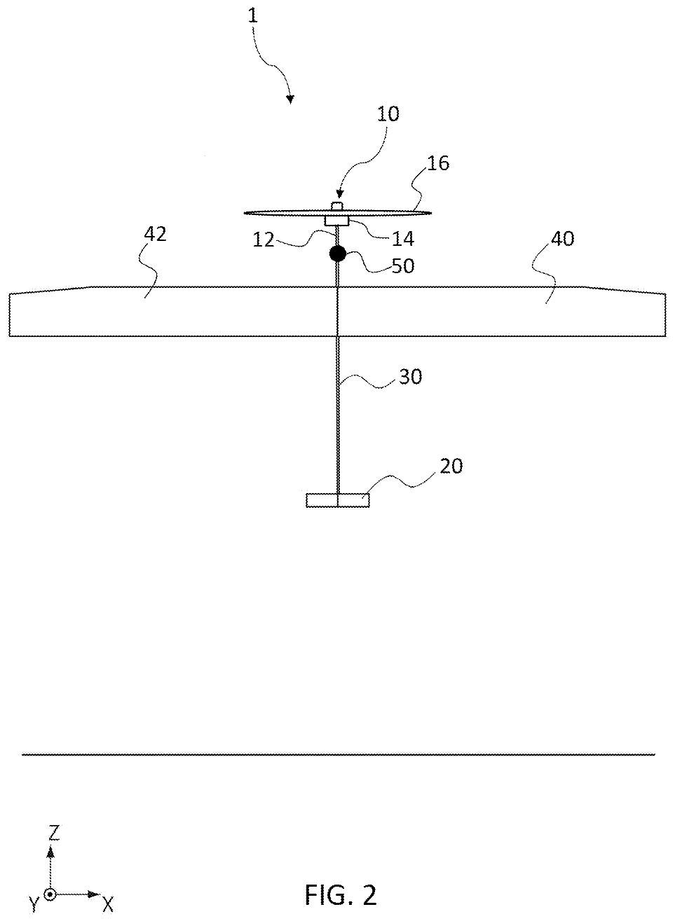

Next, the flying method for the flying body according to the present embodiment will be described with reference to FIGS. 2 to 7.

FIG. 2 is illustrating an initial state of the flying body. In the initial state, the flying body 1 is standing with the tail 20 in contact with the ground. In other words, in the initial state, the flying body 1 is set so that the fuselage 30 is standing in the vertical direction.

In the initial state, an auxiliary arm, an auxiliary leg, or the like can be used to prevent the flying body from falling.

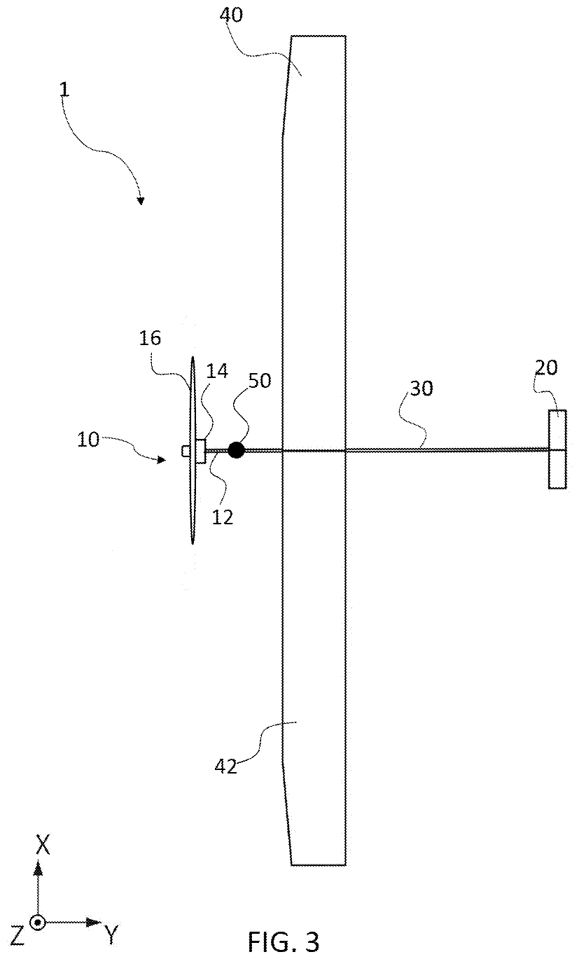

The flying body 1 obtains an upward thrust by rotating the propeller 16 of the thrust unit 10 from the state shown in FIG. 2, and floats and ascends (ascending posture) as shown in FIG. 3.

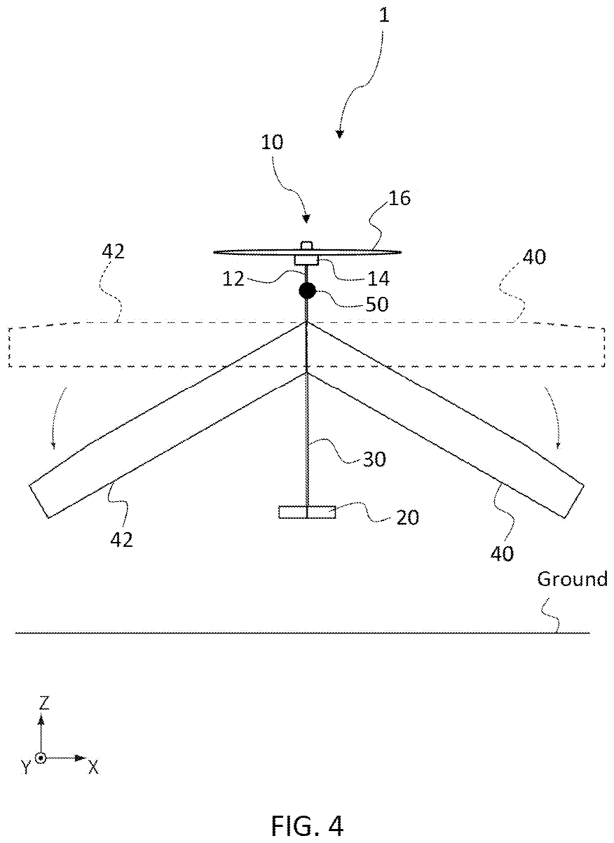

When the flying body 1 ascends up to a predetermined height, the thrust unit 10 is displaced toward the horizontal direction by approximately 90 degrees to change the direction of the vehicle body (horizontal posture), as shown in FIG. 4.

In this state, it becomes possible to propel in the horizontal direction by a principle similar to a propeller airplane. According to such a configuration, it becomes possible to move to the sky above the destination at a high speed. In horizontal level flight, the flying body 1 could take all the forms that exist in the actual aircraft, from the forward wing to the gentle swept-back wing, and positively acquires the lift by speed.

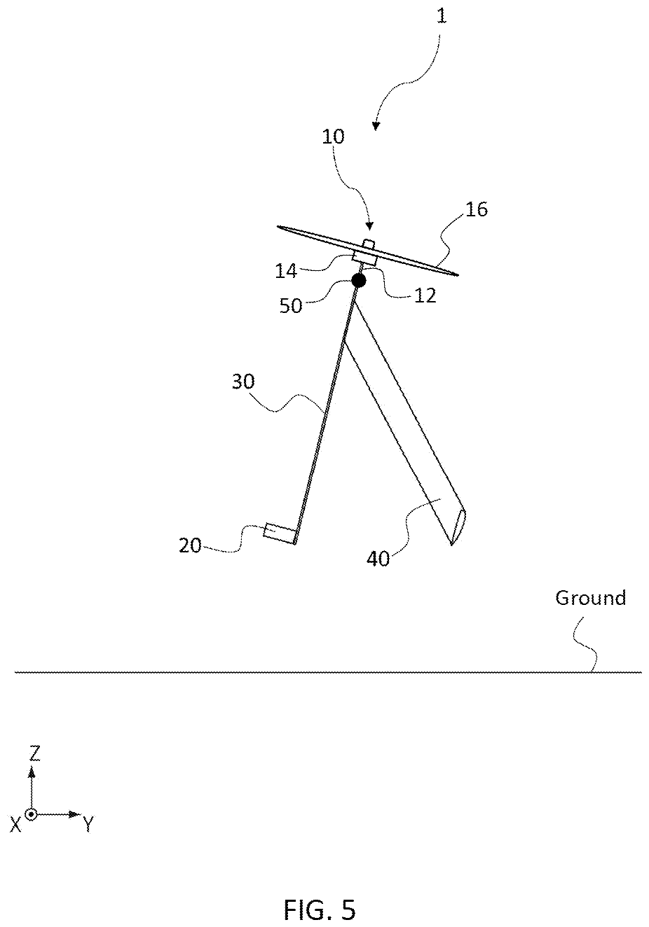

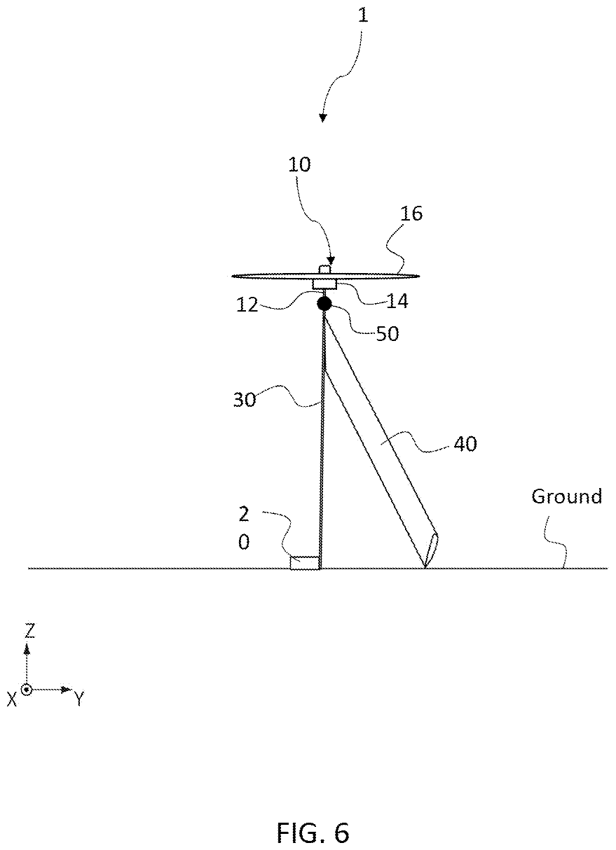

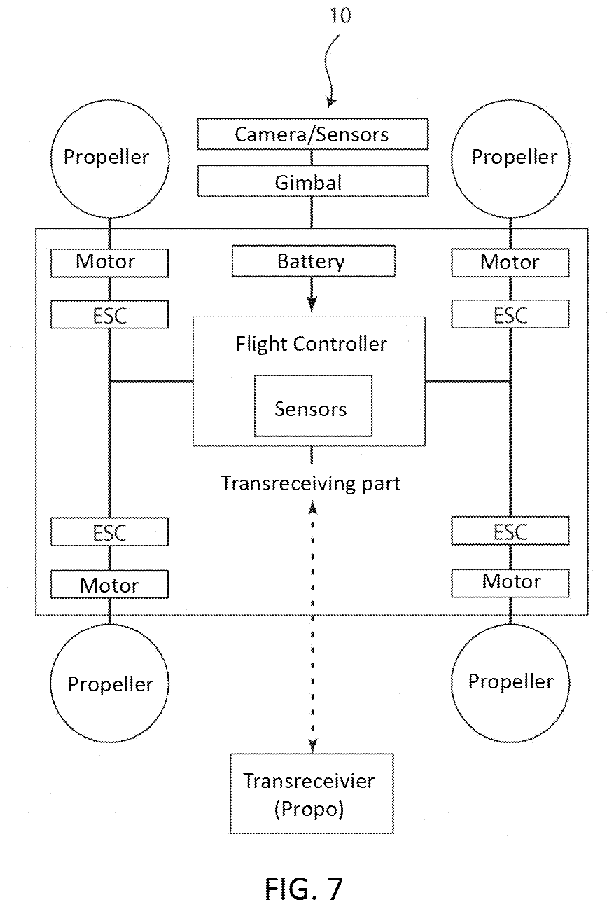

When the flying body arrives at the sky above the destination, the flying body moves vertically to a hovering state while lowering the rotational speed of the propeller 16 so as to be vertical (downward posture). That is, the direction of the flying body is returned from the horizontal direction to the vertical direction. At this time, as shown in FIGS. 5 and 6, a landing gear is provided by the main wings 40 and 42 and the fuselage 30. In this state, as shown in FIG. 5, the two wings are in a symmetrical state forming a substantially inverted V shape on both sides of the fuselage 30, and are inclined downward in a substantially straight line toward the rear. Then, as shown in FIG. 7, a part of the main wing becomes a swept wing in the landing mode. As a result, the center of gravity G also shifts to the leg side.

In the present embodiment, since a landing gear is provided by the main wings 40 and 42 and the fuselage 30, favorable landing performance can be obtained by lowering the center of gravity G while reducing the influence of the propeller wake.

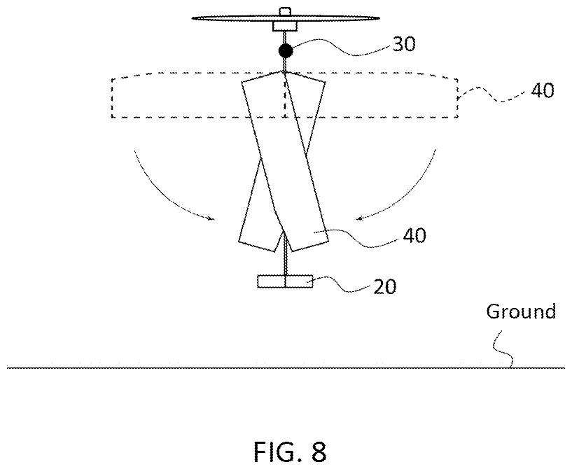

The above-described rotary-flying aircraft has, for example, a functional block as shown in FIG. 8. Further, the functional block of FIG. 8 is a minimum reference structure. A flight controller is a so-called processing unit. The processing unit may have one or more processors, such as a programmable processor (e.g., a central processing unit (CPU)).

The processing unit has a memory that is not shown, and it is possible to access the memory. The memory stores logic, codes, and/or program instructions that can be executed by the processing unit in order to perform one or more steps.

The memory may include, for example, a separable medium such as an SD card or random access memory (RAM) or an external storage device. Data obtained from cameras and sensors may be transmitted directly to the memory and stored. For example, still image dynamic image data taken by a camera or the like is recorded in a built-in memory or an external memory.

The processing unit includes a control module configured to control the state of the rotary-flying aircraft. For example, the control module may control a propulsion mechanism (such as a motor) of the rotary-flying aircraft in order to adjust the spatial arrangement, velocity, and/or acceleration of the rotary-flying aircraft having six degrees of freedom (translational motions x, y, and z, and rotational motions θx, θy, and θz). The control module can control one or more of the states of a mounting part and sensors.

The processing unit can communicate with a transreceiving part configured to transmit and/or receive data from one or more external devices (e.g., a terminal, a display device, or other remote controller). The transreceiver can use any suitable communication means such as wired or wireless communication.

For example, the transreceiving part can use one or more of a local area network (LAN), a wide area network (WAN), infrared, wireless, WiFi, point-to-point (P2P) network, telecommunication network, cloud communication, and the like.

The transreceiving part can transmit and/or receive one or more of, data acquired by a sensor or the like, a process result generated by the processing unit, predetermined control data, a user command from a terminal or a remote controller, and the like.

Sensors according to the present embodiment may include inertial sensors (acceleration sensors, gyro sensors), GPS sensors, proximity sensors (e.g., LiDAR), or vision/image sensors (e.g., cameras).

The flying body of the present invention can be expected to be used as a flying body for monitoring and investigation work, and as an industrial flying body in warehouses, factories or outdoors. In addition, the flying body of the present invention can be used in airplane-related industries such as multicopters and drones. Furthermore, the present invention can be used as a flying body for investigation equipped with a camera or the like, and also can be used in various industries such as the field security field, agriculture, infrastructure monitoring.

The embodiment described above is merely an example to facilitate the understanding of the present invention and are not intended to limit the present invention. It goes without saying that the present invention can be modified and improved without departing from the spirit and scope thereof, and the present invention includes its equivalents.

In the above-described embodiment, an example is shown in which the two wings form a substantially inverted V shape on both sides of the fuselage 30 at the time of landing of the flying body 1. However, it is not limited thereto. For example, the two wings may be provided on the fuselage 30 so as to be foldable below the vehicle body. The use of folding wings has the advantage of being easy to store, transport and maintain on the ground and being inexpensive.

### DESCRIPTION OF REFERENCE NUMERALS

1: flying body
10: thrust unit
16: propeller (rotary vane)
20: tail
30: fuselage
40, 42: wing

1. A flying body comprising:
a fuselage which is extending in one direction;
a thrust unit for generating thrust which is connected to the fuselage;
a tail which is connected to the end of the fuselage;
a main wing which is provided on the fuselage and comprises of a pair of wings extending in a direction perpendicular to the extending direction of the fuselage;
a control unit to control the main wing,
wherein the control unit deforms the main wing to bend the pair of wings closer to the fuselage and ground the tips of the pair of the wings when landing the flying body so that the end of the fuselage on the side where the tail is provided is grounded.

2. The flying body according to claim 1,
wherein the thrust unit and the fuselage are configured to be independently displaceable via a connection part.

3. (canceled)

4. The flying body as in claim 1,
wherein the main wing is located at the substantially center of the fuselage.

5. The flying body as in claim 2,
wherein the main wing is located at the substantially center of the fuselage.

6. The flying body as in claim 1,
wherein the thrust unit is located at the front end of the fuselage.

7. The flying body as in claim 2,
wherein the thrust unit is located at the front end of the fuselage.

8. The flying body as in claim 4,
wherein the thrust unit is located at the front end of the fuselage.

9. The flying body as in claim 5,
wherein the thrust unit is located at the front end of the fuselage.

10. A flight control method of a flying body,
wherein the flying body comprises:
a fuselage extending in one direction;
a thrust unit for generating thrust which is connected to the fuselage;
a tail which is connected to the end of the fuselage;
a main wing which is provided on the fuselage and comprises of a pair of wings extending in a direction perpendicular to the extending direction of the fuselage,
wherein, at the time of landing of the flying body, the method controls the fuselage along a substantially vertical direction, deforms the main wing to bend the pair of wings closer to the fuselage, and controls the end of the fuselage on the side where the tail is provided and the tip of each of the pair of wings to ground.
